(19) United States
(12) Patent Application Publication
(10) Pub. No.: US 2016/0341310 A1
(43) Pub. Date: Nov. 24, 2016

(54) BUILT-IN SYNCHRONIZER AND SHIFT CONTROL MECHANISM THEREOF

(71) Applicant: Lianghong Zhao, Foshan Guangdong (CN)

(72) Inventor: Lianghong ZHAO, Foshan Guangdong (CN)

(21) Appl. No.: 15/107,925

(22) PCT Filed: Nov. 13, 2014
(86) PCT No.: PCT/CN2014/091006

§ 371 Date: Jun. 24, 2016

(30) Foreign Application Priority Data
Jan. 18, 2014 (CN) 201410021959.3

(51) Int. Cl. F16H 63/30; F16D 23/02

(52) U.S. Cl. CPC F16H 63/30; F16H 63/304; F16H 63/3023; F16D 23/02

(57) ABSTRACT

The present invention discloses a built-in synchronizer, comprising mounting shafts and gears, with the gears being sheathed on the mounting shaft; and further comprising a spline hub, a deflector rod, and a bidirectional synchronization ring. The spline hub is connected to the mounting shaft. A concave cavity is arranged on each of the gears. A side wall of each concave cavity is provided with an inner joint gear ring. A hollow shaft sleeve is disposed in the mounting shaft, and a slot hole is provided on the shaft sleeve. One end of the deflector rod is embedded into the spline hub, and the other end of the deflector rod penetrates the slot hole of the shaft sleeve and is inserted in to an inner cavity of the shaft sleeve. An outer gear ring of the spline hub is adapted to the inner joint gear ring of each of the gears. The bidirectional synchronization ring is provided among the spline hub and the side walls of the concave cavities of the gears. The built-in synchronizer has the advantages that on the basis of the existing parallel-axis gear transmission, the built-in synchronizer and a shift control mechanism thereof are adopted, such that gears in the transmission are compactly arranged, axial size of the transmission is reduced, the size and weight of the transmission is reduced accordingly, and manufacture cost is also reduced.

### TECHNICAL FIELD

The present invention relates to the technical field of vehicle transmissions, and more specifically, to a novel synchronizer of a parallel-axis transmission, and a shift control mechanism thereof.

### BACKGROUND ART

A synchronizer of a vehicle parallel-axis transmission is a dynamic jointing or disjointing apparatus which is located in a shift gear or between two shift gears. A synchronizer applied currently will occupy a part of axial space, such that axial size of the transmission becomes larger to influence arrangement of an engine and the transmission, particularly in a transverse engined and front-wheel drive vehicle. If the number of gears is increased in case of not increasing the number of transmission shafts, it is possible to result in increased axial size of the transmission; and if the number of gears is increased in case of increasing the number of transmission shafts, it is possible to result in increased radial size of the transmission, and these both results will result in increased size and weight of the transmission; and therefore, owing to a smaller number of gears of the transmission of the existing transverse engined and front-wheel drive vehicle, the dynamic property and the economy of the vehicle will be not ideal, with relatively poor gear shift smoothness of the transmission.

### SUMMARY OF THE INVENTION

The present invention aim s to provide a built-in synchronizer having a more compact structure, and a shift control mechanism thereof, for a purpose of reducing axial size and radial size of a transmission to over the defects of the prior art.

The technical solution adopted in the present invention resides in that: an built-in synchronizer comprises mounting shafts and gears, with the gears being sheathed on the mounting shaft, and further comprises a spline hub, a deflector rod, and a bidirectional synchronization ring, wherein the spline hub is connected to the mounting shaft; a hollow cavity is arranged on each of the gears; a side wall of each hollow cavity is provided with an inner joint gear ring; a hollow shaft sleeve is disposed in the mounting shaft, a slot hole is provided on the shaft sleeve; one end of the deflector rod is embedded into the spline hub, and the other end of the deflector rod penetrates the slot hole of the shaft sleeve and is inserted into an inner cavity of the shaft sleeve; an outer gear ring of the spline hub is adapted to the inner joint gear ring of each of the gears; and the bidirectional synchronization ring is provided among the spline hub and the side walls of the hollow cavities of the gears.

The side wall of the hollow cavity of each gear is provided with an internal friction con e surface; the bidirectional synchronization ring is correspondingly provided with an external cone surface; a plurality of sliding blocks are uniformly disposed between the bidirectional synchronization ring and the spline hub in a circumferential direction; a sliding block slot in which a spring is disposed is formed inside the bidirectional synchronization ring; and one end of the spring props against the sliding blocks.

The outer circle of the spline hub is provided with a positioning slot, and a protuberance which is used to extend to and is positioned in the positioning slot is disposed on the outer wall of each sliding block.

A shift control mechanism of a built-in synchronizer, comprising the built-synchronizer, and further comprising a shift control mechanism, wherein the shift control mechanism is provided outside the mounting shaft, and the shift shaft is connected to the shift control mechanism and the end of the deflector rod.

A shift control mechanism of a built-in synchronizer comprises the built-in synchronizer, as well as a shift control piston and a hydraulic cylinder, wherein the shift control piston is disposed in the shaft sleeve and is connected to the end of the deflector rod.

A shift control mechanism of a built-in synchronizer comprises the built-in synchronizer, and a drive motor disposed in side the shaft sleeve, wherein a motor output shaft of the drive motor is connected to the end of the deflector rod.

The present invention has the following advantages: on the basis of the existing parallel-axis gear transmission, the built-in synchronizer and the shift control mechanism thereof are adopted, such that gears in the transmission are compactly arranged, and axial size of the transmission is reduced greatly in case of same gears; and the control mechanism is integrally or partially disposed inside the shaft, such that axial size of the transmission is reduced, the size and weight of the transmission is reduced accordingly, and manufacture cost is also reduced. According to the present invention, the number of transmission gear pairs may be increased in case of not changing axial size of the transmission, such that the number of gears of the transmission is increased, the vehicle has better dynamic property and economy, and meanwhile, the gear shift smoothness is improved.

### BRIEF DESCRIPTION OF THE DRAWINGS

FIG. 1(a) is a structural view of the built-in synchronizer of the present invention.

FIG. 1(b) is an A-A sectional view of FIG. 1(a).

FIG. 2 is a structural schematic view of the built-in synchronizer in a low gear.

FIG. 3 is a structural schematic view of the built-in synchronizer in a high gear.

FIG. 4 is an application schematic view of Embodiment 1 of the built-in synchronizer and the shift control mechanism thereof.

FIG. 5 is an application schematic view of Embodiment 2 of the built-in synchronizer and the shift control mechanism thereof.

FIG. 6 is a schematic view of a motor-driven built-in synchronizer.

### DETAILED DESCRIPTIONS OF THE PREFERRED EMBODIMENTS

According to the present invention, a synchronizer is disposed between a transmission gear and a gear shaft and the shift control mechanism is partially or integrally disposed inside the gear shaft, and all the types of synchronizers and transmission control modes may be applied to the present invention.

The technical solution of the present invention will be illustrated below with a lock ring synchronizer mounted on an output shaft as an example.

a built-in synchronizer comprises mounting shaft and gears, with the gears 3 being sheathed on the mounting shafts (including an output shaft, an intermediate shaft, etc.), and further comprises a spline hub 10, a deflector rod 11 and a bidirectional synchronization ring 6, wherein the spline hub 10 is connected to the mounting shaft; a hollow cavity is arranged on each of the gears; a side wall of each hollow cavity is provided with an inner joint gear ring 2; a hollow shaft sleeve is disposed in the mounting shaft, and a slot hole is provided on the hollow shaft sleeve; one end of the deflector rod 11 is embedded into the spline hub 10, and the other end of the deflector rod 11 penetrates the slot hole of the shaft sleeve and is inserted into an inner cavity of the shaft sleeve; an outer gear ring of the spline hub is adapted to the inner joint gear ring 2 of each of the gears; and the bidirectional synchronization ring 6 is provided among the spline hub 10 and the side walls of the hollow cavities of the gears. The side wall of the hollow cavity of each gear is provided with an internal friction cone surface 4; the bidirectional synchronization ring is correspondingly provided with an external cone surface 5; a plurality of sliding blocks 9 are uniformly disposed between the bidirectional synchronization ring and the spline hub in a circumferential direction; a sliding block slot in which a spring 7 is disposed is formed inside the bidirectional synchronization ring; and one end of the spring 7 props against the sliding blocks 9.

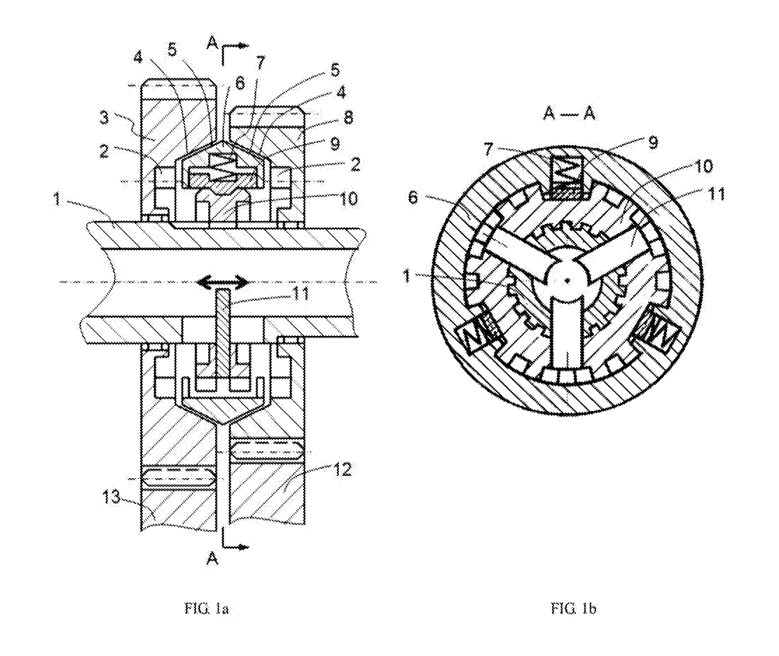

As shown in FIG. 1(a) and FIG. 1(b), each gear comprises a low-gear driven gear 3 and a high-gear driven gear 4, both of which are sheathed on the output shaft 1, and the internal joint gear ring 2 and the internal friction cone surface 4 are machined on an inner ring of each gear.

The spline hub 10 is connected to the output shaft 1 through an internal spline; the bidirectional synchronization ring is connected to the spline hub 10 through an internal spline; and the spline hub 10 can make an axial left-right movement relative to the output shaft 1 and the bidirectional synchronization ring 6, such that an outer gear ring of the spline hub 10 is in meshed connection with the inner joint gear rings 2 of the gears on both sides.

Three sliding blocks 9 are disposed between the bidirectional synchronization ring 6 and the spline hub 10 and are uniformly arranged in a circumferential direction, wherein a protuberance is disposed in the middle of one surface, facing to the spline hub 10, of each of the sliding blocks and is compressed into the positioning slot of the spline hub 10 under the action of the spring 7 to play a positioning role. Two external cone surfaces 5 are machined on the outer surface of the bidirectional synchronization ring 6 and are opposite to the internal friction cone surfaces 4 of the gears.

The deflector rod 11 is arranged on the spline hub 10, with one end of the deflector rod 11 extending out of the output shaft 1 provided with a slot hole; and the deflector rod 11 can be driven to move left and right by virtue of a control force, such that the corresponding g ear joint gear ring is jointed to the spline hub 10, and transmission of power in different gears is achieved accordingly.

In case of being in a neutral position, the spline hub 10 is located in the middle, the protuberance in the middle of each sliding block 9 is located in the positioning slot of the spline hub 10, and the spline hub 10 is not jointed to the internal joint gear rings 2 of the left and right high-speed and low-speed gears, without transmission of power.

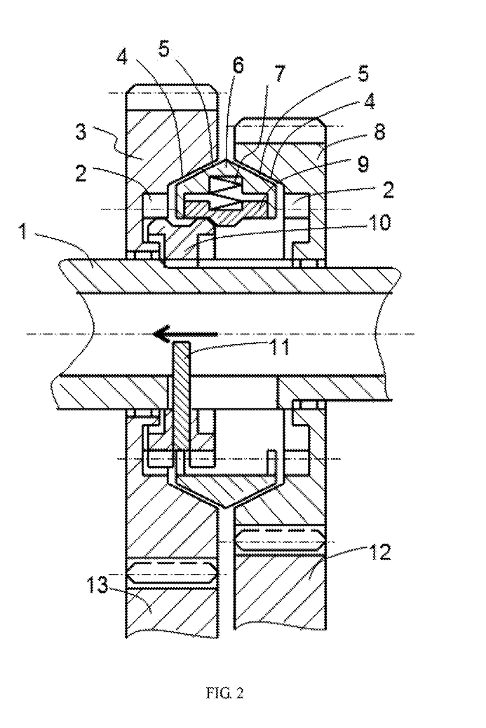

As shown in FIG. 2, the deflector rod 11 moves leftward under the pushing of the control force in case of an inclination to a lower gear; because the sliding blocks 9 are compressed in the positioning slot of the spline hub 10 under the action of the spring 7, the sliding blocks 9 move leftward together with the bidirectional synchronization ring 6, such that a left external cone surface of the bidirectional synchronization ring 6 is in contact with the internal friction cone surface of the low-gear driven gear 3; because a shift gear to be jointed has a speed difference with the synchronization ring in case of gear shift of the transmission, the external cone surfaces will be frictional with the internal friction core surfaces, the speed difference between the gear and the synchronization ring is gradually reduced under the action of the friction force; and when the gear and the synchronization ring are identical in speed, the spline hub 10 is jointed to the inner joint gear ring 2 of the low-gear driven gear 3, and by this time, power is transferred from a low-gear driving gear 13 to the low-gear driven gear 3, and is then transferred to the output shaft through the spline hub 10 to realize transmission of power in low gears.

After the spline hub 10 is jointed to the internal joint gear ring 2 in case of shifting to a low gear, the control force is eliminated, and by this time, the protuberance in the middle of each sliding block 9 props against the right side of the spline hub 10 under the compressing effect of the spring 7, and therefore the spline hub 10 fails to move rightwards and whereby causes out-of-gear.

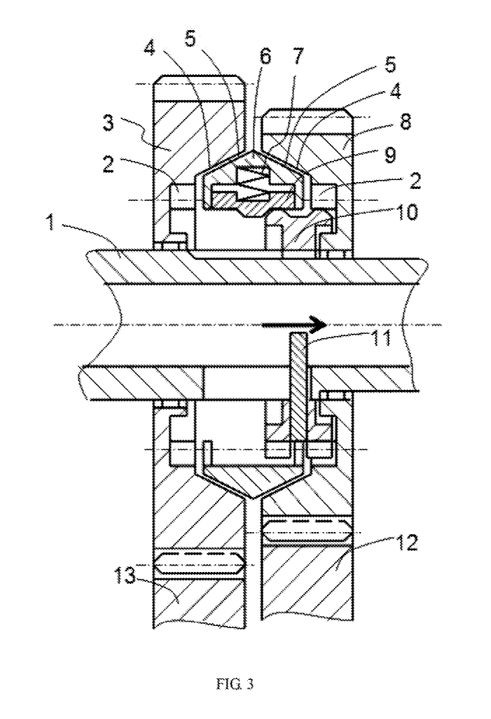

As shown in FIG. 3, the process in case of an inclination to a high gear is consistent with that in case of shifting to the high gear, and difference therebetween lies in that the spline hub 10 moves rightward. Power is transmitted from a high-gear driving gear 12 to a low-gear driven gear 8 and is then transmitted to the output shaft through the spline hub 10 to realize transmission of power in a high gear.

Application analysis is performed below according to the specific embodiment. It is illustrated particularly that the present invention can be applied to gear transmission mechanisms of a manual transmission, an automated mechanical transmission (AMT for short) and a dual clutch transmission, in which the number of gears is larger than 2. The specific embodiments as described herein are just for a purpose of explaining the present invention, without limiting the present invention.

### Embodiment 1

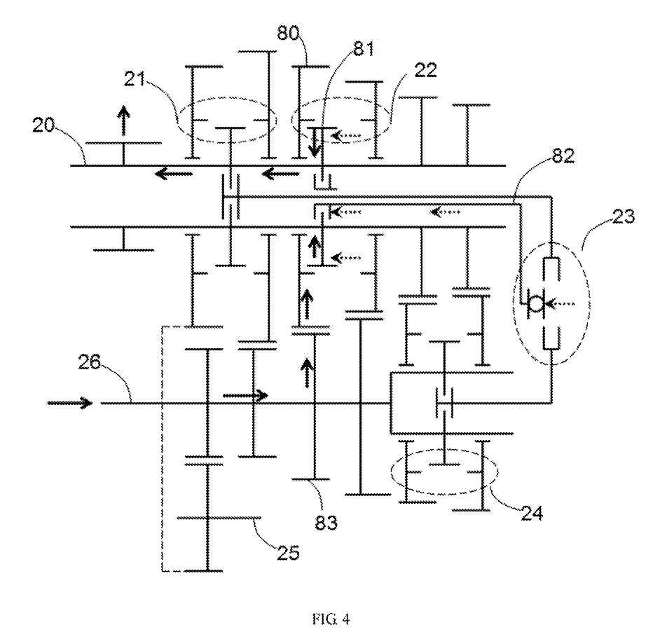

FIG. 4 is an example schematic view where the built-in synchronizer is mounted in a gear transmission mechanism of a 5-speed manual transmission or a polar automated mechanical transmission (AMT for short). This example consists of three shafts (an input shaft 26, an output shaft 20 and a reverse gear shaft 25), three synchronizers (a reverse gear and first gear synchronizer 21, a second gear and third gear synchronizer 22 and a fourth gear and fifth gear synchronizer 24), and a shift control mechanism 23.

The reverse gear and first gear synchronizer 21 and the second gear and third gear synchronizer 22 are disposed on the output shaft 20, and the fourth gear and fifth gear synchronizer 24 are disposed on the input shaft 26. The shift control mechanism 23 is partially disposed outside the input shaft and the output shaft.

When some gear is used to transmit power when needed, the shift control mechanism makes the synchronizer of the corresponding gear jointed to realize transmission of power in this gear. With a second gear as an example, when the second gear is used to transmit power when needed, a second gear and third gear shift shaft 82 and the spline hub 81 are driven to move leftward under the action of a control force of a driver, such that the spline hub 81 is jointed to jointing teeth of a second gear driven gear 80, and power is transmitted from the input shaft 26, a second gear driving gear 83, a second gear driven gear 80, the spline hub 81 to the output shaft 20, to realize power output in the second gear.

### Embodiment 2

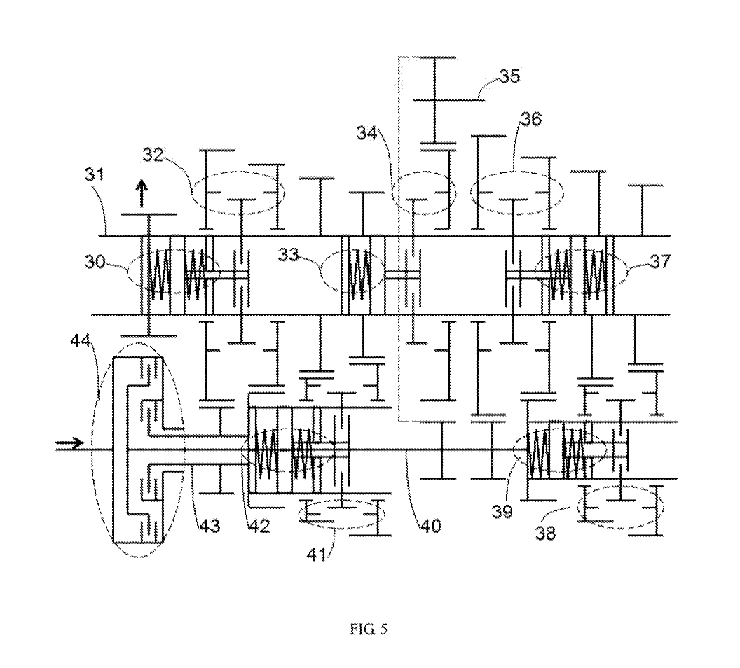

FIG. 5 shows an example in which the built-in synchronizer is mounted in a gear transmission mechanism of an 8-gear dual clutch automated transmission. In this example, a control force of the synchronizer is supplied by a hydraulic force. This example consists of four shafts (a first input shaft 40, a second input shaft 43, an output shaft 31 and a reverse gear shaft 35), five synchronizers (a first gear and third gear synchronizer 36, a second gear and fourth gear synchronizer 32, a fifth gear and seventh gear synchronizer 38, a sixth gear and eighth gear synchronizer 41 and a reverse gear synchronizer 34), and five shift control pistons (a first gear and third shift control piston 37, a second gear and fourth shift control piston 30, a fifth gear and seventh shift control piston 39, a sixth and eighth shift control piston 42 and a reverse shift control piston 33).

The first gear and third gear synchronizer 36, the second gear and fourth gear synchronizer 32 and the reverse gear synchronizer 34 are disposed on the output shaft 31, wherein the reverse gear synchronizer 34 belongs to a unilateral synchronizer. The fifth gear and seventh gear synchronizer 38 is disposed on the first input shaft 40, and the sixth gear and eighth gear synchronizer 41 is disposed on the second input shaft 43. The second input shaft 43 is sheathed on the first input shaft 40, and the first input shaft 40 and the second input shaft 43 are powered by dual clutches. The first gear and third shift control piston 37, the second gear and fourth shift control piston 30 and the reverse shift control piston 33 are disposed inside the output shaft 31, the fifth gear and seventh shift control piston 39 is disposed inside the first input shaft 40, and the sixth gear and eighth shift control piston 42 is disposed inside the second input shaft 43.

When some gear is used to transmit power when needed, the shift control pistons make the synchronizer of the corresponding gear engaged under the action of hydraulic force, to realize transmission of power in this gear

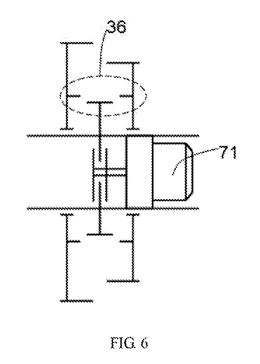

Furthermore, except for depending on manpower and hydraulic force as shift control forces, the synchronizer may also be driven by external forces, e.g., from a motor; and with first and third gear control in Embodiment 2 as shown in FIG. 6 as an example in which a motor is adopted for driving, a drive motor 71 may be mounted inside the shaft directly so as to reduce the size of the transmission.

1. A built-in synchronizer, comprising mounting shafts and gears, with the gears being sheathed on the mounting shaft, and further comprising a spline hub, a deflector rod and a bidirectional synchronization ring, wherein the spline hub is connected to the mounting shaft; a hollow cavity is arranged on each of the gears; a side wall of each hollow cavity is provided with an inner joint gear ring; a hollow shaft sleeve is disposed in the mounting shaft, and a slot hole is provided on the hollow shaft sleeve; one end of the deflector rod is embedded into the spline hub, and the other end of the deflector rod penetrates the slot hole of the shaft sleeve and is inserted into an inner cavity of the shaft sleeve; an outer gear ring of the spline hub is adapted to the inner joint gear ring of each gear; and the bidirectional synchronization ring is provided among the spline hub and the side walls of the hollow cavities of the gears.

2. The built-in synchronizer according to the claim 1, wherein the side wall of the hollow cavity of each gear is provided with an internal friction cone surface; the bidirectional synchronization ring is correspondingly provided with an external cone surface; a plurality of sliding blocks are uniformly disposed between the bidirectional synchronization ring and the spline hub in a circumferential direction; a sliding block slot in which a spring is disposed is formed inside the bidirectional synchronization ring; and
one end of the spring props against the sliding blocks.

3. The built-in synchronizer according to the claim 1, wherein the outer circle of the spline hub is provided with a positioning slot, and a protuberance which is used to extend to and is positioned in the positioning slot is disposed on the outer wall of each sliding block.

4. (canceled)

5. A shift control mechanism of an built-in synchronizer, comprising the built-in synchronizer according to the claim 1, as well as a shift control piston and a hydraulic cylinder, wherein the shift control piston is disposed in the shaft sleeve and is connected to the end of the deflector rod.

6. A shift control mechanism of a built-in synchronizer, comprising the built-in synchronizer according to the claim 1, and a drive motor disposed inside the shaft sleeve, wherein a motor output shaft of the drive motor is connected to the end of the deflector rod.
